(19) United States
(12) Patent Application Publication
(10) Pub. No.: US 2006/0157315 A1
(43) Pub. Date: Jul. 20, 2006

(54) Hydraulic clutch operator for a motor vehicle

(75) Inventor: Dieter Kraxner, Wurmberg (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.f. Porsche Aktiengesellschaft, STUTTGART (DE)

(21) Appl. No.: 11/331,047

(22) Filed: Jan. 13, 2006

(30) Foreign Application Priority Data
Jan. 14, 2005 (DE) 10 2005 001 861.0

(51) Int. Cl. F16D 48/06

(52) U.S. Cl. 192/85 C

(57) ABSTRACT

A hydraulic clutch mechanism for a motor vehicle includes a master cylinder assigned to a clutch pedal and a take-up cylinder assigned to a clutch. The master cylinder and the take-up cylinder are integrated in a hydraulic line running between the clutch pedal and the clutch, as is a mechanism which controls and/or delimits the fluid volume in the hydraulic fluid system. The use of a control valve in the hydraulic line to provide starting assistance and control the engagement of the clutch is suggested.

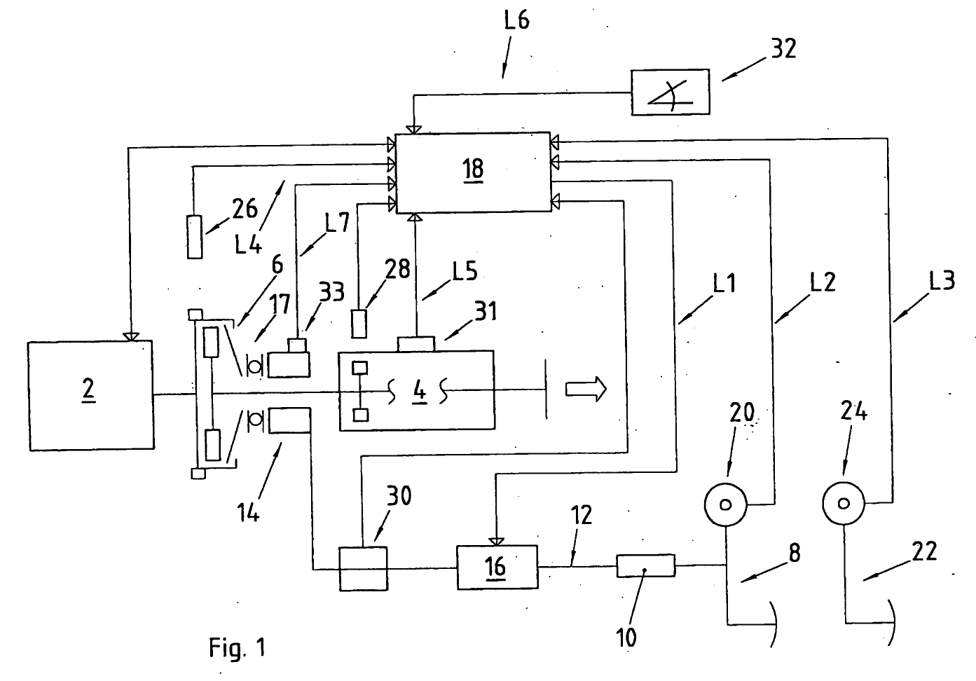

This application claims the priority of prior German application DE 10 2005 001 861.0, filed Jan. 14, 2005, the entire disclosure of which is incorporated herein by reference.

### BACKGROUND AND SUMMARY OF THE INVENTION

The present invention concerns a manual hydraulic clutch operator for a motor vehicle including a clutch pedal, a master cylinder assigned to the clutch pedal, a clutch and a take-up cylinder assigned to the clutch.

Well-known throttle mechanisms with dependent flow assistance are integrated in hydraulic lines of manually operated hydraulic clutch mechanisms and allow the generation of different flow characteristics. In a hydraulic clutch operator known, for example, from German document DE 103 11 481 A1, an adjustable piston in a cylinder is intended for use during rapid engagement of the clutch to prevent inadvertent slipping of the clutch pedal. Further forms of throttle mechanisms are known, for example, from German documents DE 198 11 137 A1 and DE 41 42 324 C2.

In automatic transmissions, engagement and/or disengagement of the clutch takes place with the help of appropriate oil feed pumps, and the opening and closing of the clutch can be guided by pressure sensors and pressure control valves arranged in the hydraulic lines (see, for example, German document DE 101 34 121 A1).

One object of this invention is to improve the functionality of a manually operated hydraulic clutch mechanism further in order to prevent slip control or, when starting in second gear, possible damage to the clutch by inadvertent fast clutching.

This object is achieved in an operator as mentioned above by way of a mechanism for controlling and/or delimiting a fluid volume in a hydraulic fluid system which is placed in that hydraulic fluid system, and a control valve which provides starting assistance in a hydraulic line running between the clutch pedal and the clutch, as well as control over engagement of the clutch. The master cylinder and the take-up cylinder, in this mechanism, are integrated in the hydraulic line running between the clutch pedal and the clutch.

During actual engagement and disengagement of the clutch through operation of the clutch pedal, the clutch engagement procedure can be guided and/or assisted in a favorable way by a corresponding control of the control valve set in the hydraulic line. This can be done, therefore, without significant additional effects on the functionality of a conventional manually operated clutch mechanism.

Through further characteristics reflected in the claims, other advantages and arrangements of the hydraulic clutch according to the invention are possible.

The cross-section of the opening of the control valve, by which the engaging speed of the clutch can be influenced, is controllable in a favorable way depending on, i.e., as a function of, the pressure in the hydraulic line. The pressure determination can be made, for example, by a pressure sensor set in the hydraulic line.

Alternatively or in addition to pressure dependent control, it is also possible to exert greater control over the disengagement speed of the clutch pedal.

Further, it is possible to regulate-the opening cross-section of the control valve in dependence on the engine parameters such as engine speed or the position of a butterfly valve. The position and/or adjustment speed of the accelerator pedal can also be taken into consideration as a further control parameter for the engaging speed of the clutch. The release of the clutch pedal can be triggered by the accelerator pedal angle, and possibly also coupled with the accelerator pedal adjustment speed, which in automated clutches is adjustable via an algorithm. For example, if the driver does not supply any gas and the clutch is depressed, then the control valve opens easily via control electronics so that the flow rate is reduced in the hydraulic line independent of the speed with which the clutch pedal is depressed. If the clutch reaches its friction point, then the vehicle can start to creep forward, as with an automated transmission with a hydrodynamic transducer.

According to the invention, assistance to the hydraulic clutch mechanism may be provided, for example, under any of the following conditions:
1. when starting in second gear,
2. when stalling of the motor is to be guarded against,
3. when starting assistance for a quick start, also known as “Kick-Down-Start,” is to be provided,
4. for slip control, and
5. to prevent throttle mechanism abuse when the driver inadvertently releases the clutch pedal.

### BRIEF DESCRIPTION OF THE DRAWINGS

One embodiment of the invention which is described in detail is shown in the drawings. The only drawing FIGURE schematically shows the structure of a manually operated hydraulic clutch mechanism.

### DETAILED DESCRIPTION OF THE INVENTION

A combustion engine, designated with the reference number 2, produces engine torque supplied to a change speed gear 4, which operates the drive wheels of the motor vehicle. A clutch 6 is arranged between the combustion engine 2 and the change speed gear 4 and serves as a link between the engine 2 and the change speed gear 4. A clutch pedal 8, which is hinged on a pivot in a motor vehicle body, is used for operation of the clutch 6. A piston rod is attached to the clutch pedal 8 and works with the designated master cylinder 10. A hydraulic line 12 leads from the master cylinder 10 to a take-up cylinder 14. The take-up cylinder 14 operates the disengagement mechanism 17 of the clutch 6.

An electrically controllable control valve 16 is set up in the hydraulic line 12 between the master cylinder 10 and the take-up cylinder 14 and has a function mode which is discussed in more detail later. As is evident from the FIGURE, the control valve 16 is connected with a control unit 18 by means of a line L1. The position of the clutch pedal 8 is obtained, with the help of a position indicator 20, by an electrical line L2 connected to the control unit 18. The position of the gas pedal 22 as operated by the driver, which is controlled by the engine butterfly valve, is obtained by a position indicator 24, which is connected by a line L3 to the control unit 18. A tachogenerator 26 in the clutch is connected by a line L4 to the control unit 18, which thereby obtains the engine speed. Further, a tachogenerator 28 is set at the entrance to the transmission and, with the help of pressure sensors 30 arranged between the take-up cylinder 14 and the pressure control valve 16 in the hydraulic line 12, detects the pressure in the hydraulic line 12. In addition, the mechanism includes a gear position sensor 31, a sensor 32 for the determination of the upward slope of the motor vehicle 15 and a course sensor 33 for the take-up cylinder 14. The sensors 31, 32 and 33 are respectively connected to the control unit 18 by lines L5, L6 and L7.

Details of the operation of the hydraulic clutch mechanism are described in the following.

Disengagement takes place in the conventional manner, i.e. the foot presses on the clutch pedal 8, producing movement which is transferred to the pistons of the master cylinder 10. Fluid pressure produced in the pressure chamber of the master cylinder increases the pressure in the hydraulic line 12 and acts on the pistons of the take-up cylinders 14 which operate the disengagement mechanism 17 and thus releases the clutch 6. During disengagement, the control valve 16, designed as an electrically controllable regulating valve, is inoperative and thus completely open so that the hydraulic fluid can flow unhindered through the hydraulic line or lines 12.

The control valve 16 and/or its opening cross-section is controlled upon clutching or engagement of the clutch by the control unit in a manner which is dependent on the following parameters:
a) pressure or a decrease of pressure in the hydraulic lines (12), and/or
b) the disengagement speed of the clutch pedal (9), and/or
c) the engine speed and/or the position of the butterfly valve, and/or
d) the position and/or the adjustment speed of the gas pedal (22), and/or
e) the gear position of the gear position sensor (31), and/or
f) the start-up number of revolutions of the tachogenerator (28), and/or
g) the incline determined by the gradient sensor (32).

In the disengaged position, the accelerator pedal can be adjusted into any position which corresponds to a minimum or maximum engine speed. The hydraulic line is now completely closed by the control valve. As soon as the engagement procedure begins and the driver engages the clutch pedal 8, no matter how fast it is released, an independent electronic control procedure begins. For example, if no gas is given, then the control valve 16 releases the opening cross-section via the engine electronics until the clutch 6 is fully depressed and the vehicle begins to “creep” forward—thus the transducer is automatically initiated. When this is coupled with, for example, maximum engine speed, then the engine electronics along with the control valve limit the fluid volume of the hydraulic fluid pressure. This guarantees that the vehicle can be started without revving the wheels (traction control). The same applies to so-called “misuse” occurring when the driver's foot inadvertently slips off the clutch pedal. For such situations, position indicators 20 can be arranged on the clutch pedal 8 so that the control valve can take control of the starting process. If an adjustment speed of the clutch pedal 8 which corresponds to a predefined limit for “normal clutching” is read, then the clutching procedure remains uninfluenced by the control electronics, i.e., it remains dead, and thus the control valve 16 remains completely open. Control valve 16 and/or its controller can carry out other additional functions.

If, during clutching, oscillations which occur in the clutch or the drive wheels are detectable by sensors, a frequency can be stored by the control unit of the control valve 16 which would act to eliminate the oscillations. Additionally, if, during a controlled engagement of the clutch, the tires start to slip, traction control can be implemented without interference.

A controlled start in second gear is possible with the engine movement and engine speed limited by the clutch load. To implement this function, the gear position sensor 31 can be set over, that is for first gear or neutral. Thus, the restrictions of engine movement and engine speed can be waived for this starting gear. It can be determined by the gradient sensor 32 whether starting in second gear can be allowed.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

I claim:

1. A hydraulic clutch mechanism for a motor vehicle, comprising:
a clutch pedal,
a master cylinder assigned to the clutch pedal,
a clutch,
a take-up cylinder assigned to the clutch,
a mechanism for controlling, delimiting, or controlling and delimiting a fluid volume in a hydraulic fluid system which is placed within the hydraulic system, and
a control valve which provides starting assistance in a hydraulic line running between the clutch pedal and the clutch as well as control over engagement of the clutch,
wherein the master cylinder and the take-up cylinder are integrated in the hydraulic line running between the clutch pedal and the clutch.

2. The hydraulic clutch mechanism according to claim 1, wherein an opening cross-section of the control valve is controlled by pressure in the hydraulic line.

3. The hydraulic clutch mechanism according to claim 2, further comprising a pressure sensor (30) set in the hydraulic line between the master cylinder and the take-up cylinder.

4. The hydraulic clutch mechanism according to claim 2, wherein the opening cross-section of the control valve is operated dependent on a disengagement speed of the clutch pedal.

5. The hydraulic clutch mechanism according to claim 2, wherein the opening cross-section of the control valve is operated dependent on engine parameters.

6. The hydraulic clutch mechanism according to claim 2, wherein the opening cross-section of the control valve is dependent on a position, an adjustment speed, or both the position and the adjustment speed of the gas pedal.

7. The hydraulic clutch mechanism according to claim 1, wherein a position of the clutch pedal or the accelerator pedal, or positions of the clutch and the accelerator pedals, is or are overseen by at least one position indicator.

8. The hydraulic clutch mechanism according to claim 1, wherein the starting assistance provides at least one of a) starting assistance for second gear, b) a stall guard for a motor, c) starting assistance for a fast start, d) slip control, and e) peak torque limitation.

9. The hydraulic clutch mechanism according to claim 5, wherein the engine parameters include at least one of engine speed and a butterfly valve position.

10. The hydraulic clutch mechanism according to claim 2, wherein the starting assistance provides at least one of a) starting assistance for second gear, b) a stall guard for a motor, c) starting assistance for a fast start, d) slip control, and e) peak torque limitation.

11. The hydraulic clutch mechanism according to claim 3, wherein the starting assistance provides at least one of a) starting assistance for second gear, b) a stall guard for a motor, c) starting assistance for a fast start, d) slip control, and e) peak torque limitation.

12. The hydraulic clutch mechanism according to claim 4, wherein the starting assistance provides at least one of a) starting assistance for second gear, b) a stall guard for a motor, c) starting assistance for a fast start, d) slip control, and e) peak torque limitation.

13. The hydraulic clutch mechanism according to claim 5, wherein the starting assistance provides at least one of a) starting assistance for second gear, b) a stall guard for a motor, c) starting assistance for a fast start, d) slip control, and e) peak torque limitation.

14. The hydraulic clutch mechanism according to claim 6, wherein the starting assistance provides at least one of a) starting assistance for second gear, b) a stall guard for a motor, c) starting assistance for a fast start, d) slip control, and e) peak torque limitation.

15. The hydraulic clutch mechanism according to claim 7, wherein the starting assistance provides at least one of a) starting assistance for second gear, b) a stall guard for a motor, c) starting assistance for a fast start, d) slip control, and e) peak torque limitation.

16. The hydraulic clutch mechanism according to claim 3, wherein the opening cross-section of the control valve is operated dependent on engine parameters.

17. The hydraulic clutch mechanism according to claim 3, wherein the opening cross-section of the control valve is dependent on a position, an adjustment speed, or both the position and the adjustment speed of the gas pedal.

18. The hydraulic clutch mechanism according to claim 2, wherein a position of the clutch pedal or the accelerator pedal, or positions of the clutch and the accelerator pedals, is or are overseen by at least one position indicator.

19. The hydraulic clutch mechanism according to claim 3, wherein a position of the clutch pedal or the accelerator pedal, or positions of the clutch and the accelerator pedals, is or are overseen by at least one position indicator.

20. The hydraulic clutch mechanism according to claim 4, wherein a position of the clutch pedal or the accelerator pedal, or positions of the clutch and the accelerator pedals, is or are overseen by at least one position indicator.
